(19) United States
(12) Patent Application Publication
(10) Pub. No.: US 2007/0266799 A1
(43) Pub. Date: Nov. 22, 2007

(54) Piezoelectric sensor system and entrapment-detecting device

(75) Inventor: Takehiko Sugiura, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/783,500

(22) Filed: Apr. 10, 2007

(30) Foreign Application Priority Data
Apr. 14, 2006 (JP) 2006-112495

(51) Int. Cl. G01L 5/00; G01L 1/16

(52) U.S. Cl. 73/862.541

(57) ABSTRACT

A piezoelectric sensor system includes a piezoelectric sensor for outputting an electric voltage in accordance with a mechanical external force, delaying apparatus for delaying the output from the piezoelectric sensor for a predetermined delaying time period, AC amplifying apparatus for applying AC amplification to the output from the piezoelectric sensor via the delaying apparatus, and determining apparatus for determining whether or not the external force is applied to the piezoelectric sensor, on the basis of the output from the AC amplifying apparatus and for determining whether or not the piezoelectric sensor system normally operates on the basis of the output from the AC amplifying apparatus during the delaying time period.

### CROSS REFERENCE TO RELATED APPLICATIONS

This application is based on and claims priority under 35 U.S.C. §119 to Japanese Patent Application 2006-112495 filed on Apr. 14, 2006, the entire content of which is incorporated herein by reference.

### FIELD OF THE INVENTION

The present invention relates to a piezoelectric sensor system having a piezoelectric sensor for outputting electric voltage in accordance with a mechanical external force, an amplifying means for amplifying the output from the piezoelectric sensor and a determining means for determining on the basis of the output from the amplifying means whether or not the external force is applied to the piezoelectric sensor. The present invention further relates to an entrapment-detecting device having the piezoelectric sensor system applied to an opening/closing system.

### BACKGROUND

Recently, some approaches for controlling various types of instruments have been carried out by detecting sensory information and even extrasensory information. A lot of information is required in order to execute the control for such instrument so as to improve convenience and safety thereon, and such instrument uses various sensor systems. The above mentioned piezoelectric sensor system can be applied to such as an entrapment-detecting device for an electric moving door. Specifically, an electric opening/closing device for sliding a door by means of a motor so as to be opened or closed has been provided at an automatic moving door of a building, an electric moving slide door of a vehicle or a train include or the like. With such electric opening/closing device, an entrapment may occur at the door, specifically, an object may be sandwiched between a door and a jamb during an opening/closing operation. In this situation, it is important to provide the entrapment-detecting device in order to stop the closing operation or switch the closing operation to the opening operation.

The piezoelectric element uses an electric polarization (piezoelectric effect) generated in accordance with an external force. Specifically, even when the sensor is bent, it may not output a detection signal until the external force is applied thereto when the sensor is in a stable condition. Accordingly, the sensor can be provided at various places by means of various attachment methods. Further, because an electric voltage is generated by the piezoelectric element even when the external force is still weak, the object can be detected in the early stage of the entrapment. Because of this advantage, such device has been in demand.

Because the signal outputted from the piezoelectric effect is generally very weak, such signal needs to be amplified. However, in DC amplification circuit, because of an offset electric voltage being large, it is difficult to sufficiently amplify the signal within a power electric voltage range of the amplifier. For such cases, a known method is used in order to apply AC amplification to a signal by means of a coupling condenser, a signal to which an impedance conversion is applied (may also be DC amplification at an early stage). By means of the AC amplification, because the amplifier can amplify the signal by effectively using the power electric voltage range thereof, the weak signal generated by the piezoelectric effect can be sufficiently amplified. However, because the signal, to which the AC amplification is applied, is zero in amplitude in a stable condition, it becomes difficult to determine whether or not the system functions correctly on the basis of the output from the piezoelectric sensor.

This kind of sensor system would be beneficial to control the instrument, however, when the sensor system does not function correctly, the instrument may be operated improperly, and such situation is not favorable. Accordingly, the sensor system often executes a self-diagnosis so as to inform the result to the control device of the instrument.

A known art disclosed in Japanese patent publication of JPH10-300615A relates to a diagnostic method for a semiconductor pressure sensor, which is one of the sensors having the abovementioned sensor system. This method is applied to a two output type semiconductor pressure sensor, each output basically having different output characteristics relative to different pressures. Specifically, a microcomputer of the system using this pressure sensor previously reads and memorizes an initial value of each output characteristic relative to a predetermined pressure force, and the two outputs relative to the pressures upon an actual operation are read, calculated and processed by the microcomputer. Further; the microcomputer can execute the self-diagnosis in order to determine whether or not the semiconductor pressure sensor functions properly in every malfunction mode.

The self-diagnosis method disclosed in JPH10-300615A can be a good method to diagnose whether or not the sensor functions correctly in every malfunction mode, however, in order to execute such diagnose, the system needs to include a microcomputer having sufficient high-efficiency. Further, a general-purpose microcomputer may output a test pattern to the sensor, in this case however, the system still needs to include the microcomputer therein. Further, an oscillating circuit and a logical circuit may output a test signal to the sensor. In this case, the system also needs to include these circuits.

When the system already has included the microcomputer or the circuit such as the oscillating circuit, there is no need to provided additional items thereat, however, the piezoelectric sensor system mainly having an analog signal processing needs to add another circuit or the like. In this situation, costs may further be increased, and the size of the circuit may be increased. Further, according to the abovementioned piezoelectric sensor system, because amplitude of the signal to which the AC amplification is applied becomes zero in a stable condition, it becomes difficult to determine whether or not the system functions correctly. Further, although it depends on an extent, the system may function correctly by applying a calibration, such as changing a criterion value. It may be preferable to prepare an adjustment function together with the self-diagnosis function of the system, however, a trade-off, such as an increment of the circuit size, may occur.

A need thus exists to provide a sensor system, especially a piezoelectric sensor system, mainly executing an analog signal processing, by which a self-diagnosis function can be achieved with a simple configuration, and further an adjustment function can be achieved with a simple configuration. Furthermore, a need exists to provide an entrapment-detecting device having the system applied to an opening/closing system.

### SUMMARY OF THE INVENTION

According to an aspect of the present invention, a piezoelectric sensor system includes a piezoelectric sensor for outputting an electric voltage in accordance with a mechanical external force, delaying means for delaying the output from the piezoelectric sensor for a predetermined delaying time period, AC amplifying means for applying AC amplification to the output from the piezoelectric sensor via the delaying means, and determining means for determining whether or not the external force is applied to the piezoelectric sensor, on the basis of the output from the AC amplifying means and for determining whether or not the piezoelectric sensor system normally operates on the basis of the output from the AC amplifying means during the delaying time period.

According to another aspect of the present invention, a piezoelectric sensor system includes a piezoelectric sensor for outputting an electric voltage in accordance with a mechanical external force, delaying means for delaying the output from the piezoelectric sensor for a predetermined delaying time period, AC amplifying means for applying AC amplification to the output from the piezoelectric sensor via the delaying means and determining means for determining whether or not the external force is applied to the piezoelectric sensor, on the basis of the output from the AC amplifying means and for setting one of an amplification ratio of the AC amplifying means and a criteria of the determining means on the basis of the delaying time period.

According to further aspect of the present invention, an entrapment-detecting device includes an opening/closing system having an opening/closing members and operated so as to be opened/closed by means of a driving force from an actuator, a piezoelectric sensor provided at an end portion of the opening/closing members for outputting an electric voltage in accordance with a mechanical external force, delaying means for delaying the output from the piezoelectric sensor for a predetermined delaying time period, AC amplifying means for applying AC amplification to the output from the piezoelectric sensor via the delaying means and determining means for determining whether or not the external force is applied to the piezoelectric sensor, on the basis of the output from the AC amplifying means, in order to detect an entrapment of an object at the opening/closing members and for determining whether or not entrapment-detecting device normally operates on the basis of the output from the AC amplifying means during the delaying time period.

### BRIEF DESCRIPTION OF THE DRAWINGS

The foregoing and additional features and characteristics of the present invention will become more apparent from the following detailed description considered with reference to the accompanying drawings, wherein:

FIG. 1 illustrates a function block diagram schematically indicating an example of a configuration of a piezoelectric sensor system related to the present invention;

FIG. 2 illustrates a graph explaining an effect caused by the delaying means;

FIG. 3 illustrates an oblique perspective view indicating an example of a configuration of a piezoelectric sensor;

FIG. 4 illustrates an oblique perspective view indicating an example of setting of the piezoelectric sensor;

FIG. 5 illustrates a function block diagram schematically indicating an example of a configuration of an entrapment-detecting device related to the present invention;

FIG. 6 illustrates a block circuit diagram schematically indicating an example of a configuration of the piezoelectric sensor system;

FIG. 7 illustrates a function block diagram schematically indicating an example of another configuration of the piezoelectric sensor system related to the present invention;

FIG. 8 illustrates a graph indicating a relation between a stray capacitance and temperature; and

FIG. 9 illustrates a function block diagram schematically indicating another example of a configuration of the entrapment-detecting device related to the present invention.

### DETAILED DESCRIPTION

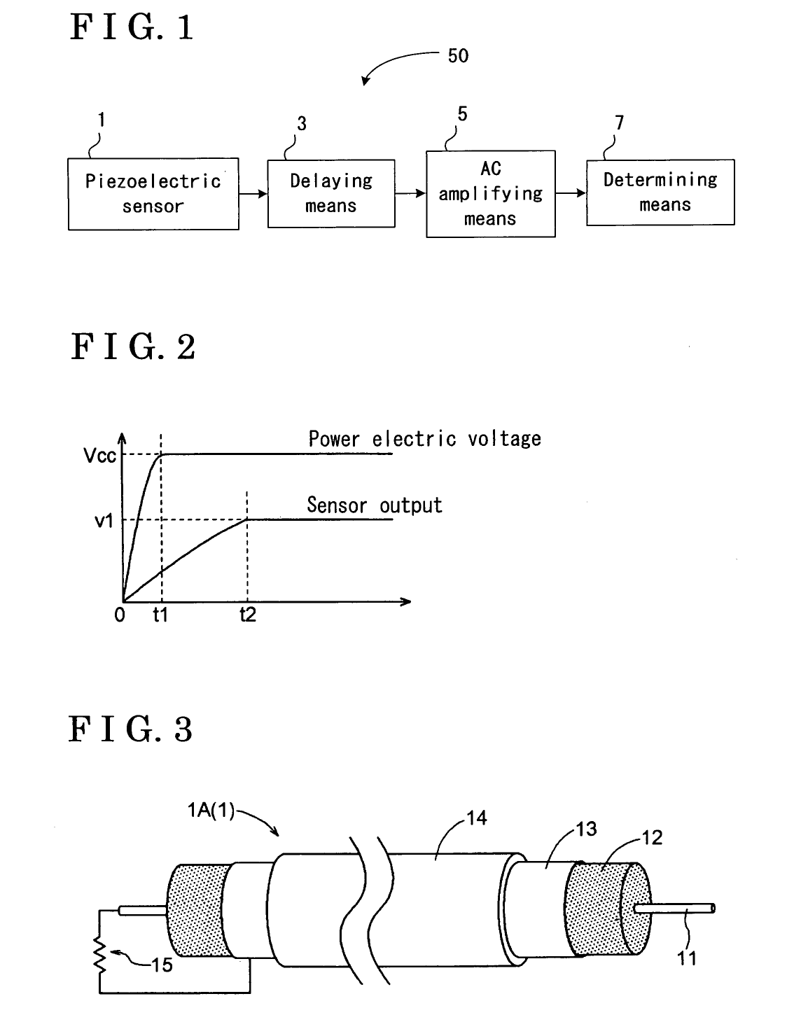

An embodiment of the present invention will be explained in accordance with the attached drawings. A piezoelectric sensor system 50 related to the present invention includes, as illustrated in FIG. 1, a piezoelectric sensor 1, an AC amplifying means 5 and a determining means 7. The piezoelectric sensor 1 outputs an electric voltage in accordance with a mechanical external force, the AC amplifying means 5 applies AC amplification to the output from the piezoelectric sensor 1, and the determining means 7 determines whether or not the external force is applied to the piezoelectric sensor 1 on the basis of the output from the AC amplifying means 5. The piezoelectric sensor system 50 further includes a delaying means 3 for delaying the output from the piezoelectric sensor 1 for a predetermined delaying time period.

As illustrated in FIG. 2, the output from the piezoelectric sensor 1 is delayed for a delaying time period, which can be indicated by (t2−t1). For example, after a level of the electric voltage of the power becomes a predetermined electric pressure level Vcc, the determining means 7 can determine whether or not the external force is applied to the piezoelectric sensor 1. When the external force is not applied to the piezoelectric sensor 1, the output from the piezoelectric sensor 1 (hereinbelow referred to as a sensor output) increases so as to reach a predetermined:bias electric voltage v1, and once the output reaches the predetermined bias electric voltage v1 of a steady-state level, it remains at this level as indicated in FIG. 2.

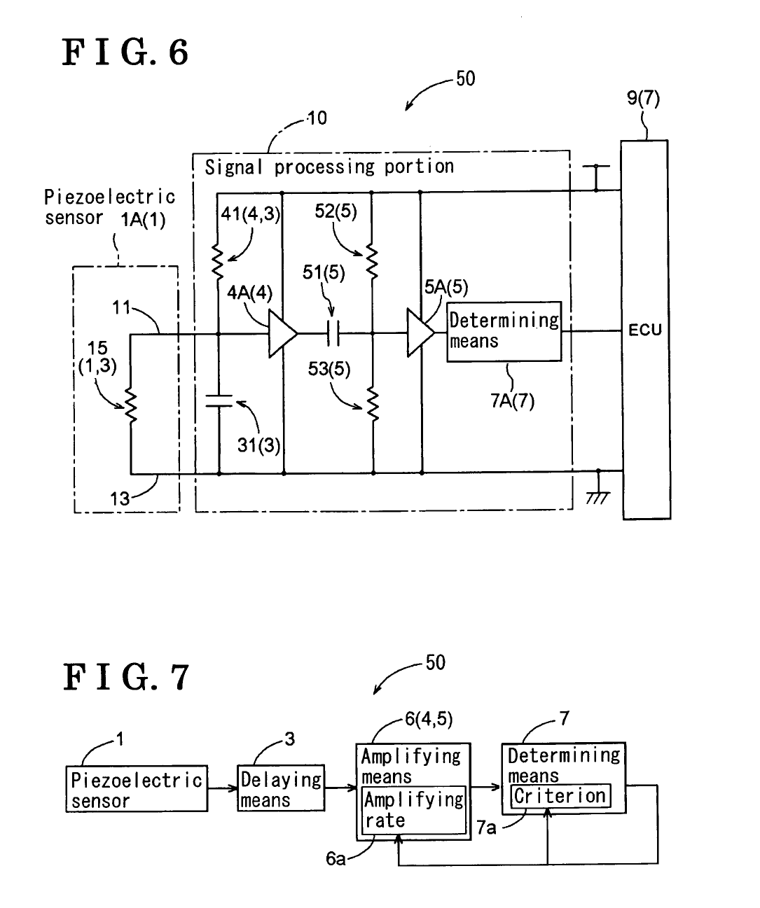

As illustrated in FIG. 2, at a point of time t1 at which the power electric voltage has already risen, the sensor output is in a transient state and has not reached the steady-stated level v1 because the sensor output is controlled by the delaying means 3 so as not to reach the steady-stated level v1 for a predetermined delaying time period. Thus, the AC amplifying means 5 would apply the AC amplification to the sensor output being a signal in a transient state The determining means 7 determines whether or not the piezoelectric sensor system 50 functions properly on the basis of the output from the AC amplifying means 5 during the delaying time period (t2−t1) after the piezoelectric sensor system 50 is turned on. For example, when a signal variation occurs during the delaying time period, the determining means 7 determines that the piezoelectric sensor system 50 functions properly. Further, when a time period during which the signal variation has continually occurred is significantly shorter or significantly longer than an assumed predetermined delaying time period, the determining means 7 may determine that the piezoelectric sensor system 50 does not function properly. Further, as described later in accordance with FIG. 6, in a case where the AC amplification is applied, the AC amplifying means 5 for applying AC amplification includes a coupling condenser. According to the present invention, it can be determined whether or not the sensor system and also the coupling condenser function properly.

FIG. 3 illustrates an oblique perspective view indicating an example of a configuration of the piezoelectric sensor 1 (1A). As illustrated in FIG. 3, the piezoelectric sensor 1A is comprised of a piezoelectric body 12 and two electrodes 11 and 13, between which the piezoelectric body 12 is sandwiched. The piezoelectric sensor 1A generates an electric charge by means of piezoelectric effect caused by a deformation on the piezoelectric body 12 so as to output an electric voltage signal between the electrodes, a deformation caused by a mechanical external force generated due to acceleration, vibrations, a contact or the like. As illustrated in FIG. 3 as an example, the piezoelectric sensor 1A includes, as electrodes, the electrode 11, which is comprised of a conducting wire or an axis around which an electric conductor is wound, and the electrode 13 formed in a tube shape. In this configuration, the piezoelectric body 12 is sandwiched between the electrode 11 and the electrode 13, and all elements are coated by a coating 14 so as to be in a coaxial cable shape. Further, a resistor 15 is connected to one end of the piezoelectric sensor 1A, formed in a coaxial cable shape, in a manner where one end of the resistor 15 is connected to the electrode 11 and the other end of the resistor 15 is connected the electrode 13. The resistor 15 is used for checking a disconnection or the like at the piezoelectric sensor 1A.

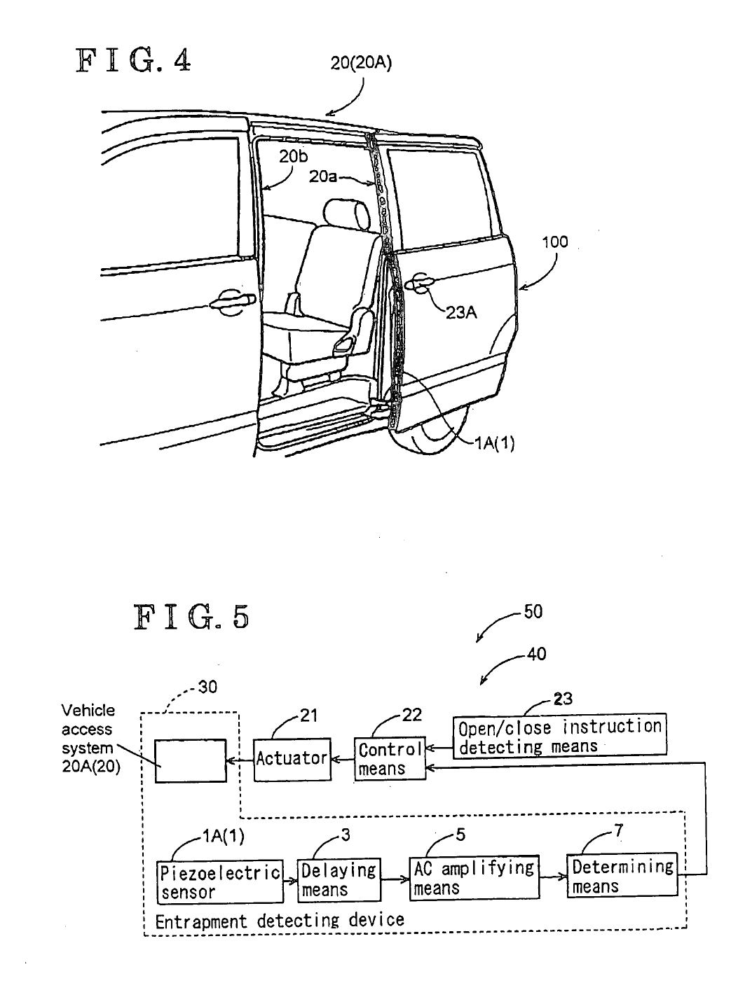

Because the piezoelectric sensor 1A is formed in a coaxial cable shape, it can detect an external load applied in a radial direction thereof and can be easily attached to a bent portion. Thus, as illustrated in FIG. 4, the piezoelectric sensor 1A can appropriately be provided at an end portion 20a of a slide door 100 (serving as an opening/closing member) of a vehicle access system 20A (serving as an opening/closing system) or an end portion 20b of a vehicle doorjamb (serving as an opening/closing member) of a vehicle access system 20A. Specifically, the end portion 20a is provided at the slide door 100 or the like, and the end portion 20b is provided at a pillar, a front door or the like. The piezoelectric sensor 1A may further be provided at the vehicle access system such as an automatic door or a revolving door of a building, a door of a train or the like. In other words, as illustrated in FIG. 5, an entrapment-detecting device 30 of the present invention is comprised of the piezoelectric sensor system 50 of the present invention.

As illustrated in FIG. 4 and FIG. 5, the entrapment-detecting device 30 includes the slide door 100 of the vehicle access system 20A, the piezoelectric sensor 1A (1) and the piezoelectric sensor system 50 having the piezoelectric sensor 1A (1). The slide door 100 includes an end portion 20a. Further, the piezoelectric sensor 1A is provided at the end portion 20a of the slide door 100. When the piezoelectric sensor 1A is provided at the end portion 20a of the slide door 100, an entrapment of an object can be detected, on the basis of the contact of the object to the vehicle access system 20A, before the object is actually sandwiched between the end portions 20a and 20b. In a case where both of the end portion 20a and the end portion 20b are movable, the piezoelectric sensor 1A may be provided at each of/one of the end portion 20a and the end portion 20b. According to the present embodiment using the vehicle access system 20A, the piezoelectric sensor 1A can be provided at the end portion 20a of the slide door 100. The vehicle access system 20A is opened/closed by the movement of the slide door 100 by means of a driving force of the actuator 21. The actuator 21 is controlled by a control means 22 of a door opening/closing control device 40. The control means 22 receives detection signals outputted by a sensor or a switch (not shown), which are provided at the door handle 23A, an open/close instruction detecting means 23 such as a switch provided within a vehicle interior and the like.

The control means 22 receives a detection result of the entrapment-detecting device 30, and on the basis of the detection result, the driving force generated by the actuator 21 and applied to the vehicle access system 20A is controlled. For example, the control means 22 controls the actuator 21 to decelerate, stop or reverse when an entrapment is detected. The entrapment includes a contact and an abutting to the end portion 20a of the slide door 100. Further, the control means 22 may execute a control to reduce the speed of the opening/closing operation in accordance with a result of a self-diagnosis of the piezoelectric sensor system 50. Specifically, when it is determined that the piezoelectric sensor system 50 does not function properly, the external force applied to the object upon the entrapment can be reduced by reducing the speed of the opening/closing operation of the vehicle access system 20A.

Further, depending on a state of the vehicle access system 20A, electric power is supplied to the entrapment-detecting device 30. Specifically, the control means 22 starts supplying an electric power to the piezoelectric sensor system 50 at a point when the electric power is supplied to the actuator 21. When the vehicle access system 20A is not operated so as to be opened/closed, an entrapment caused by a sandwich condition does not occur. Further, even when the abutting (contact) of the object to the vehicle access system 20A occurs, it is considered that a possibility where the object will be sandwiched is significantly low. Thus, the piezoelectric sensor system 50 is turned on depending on the state of the vehicle access system 20A, accordingly an unused stand-by electric power may not be consumed, Further, the piezoelectric sensor system 50 according to the present invention executes a self-diagnosis in accordance with the delaying time period after the power is supplied thereto. Thus, because the self-diagnosis is executed on every opening/closing operation, reliability of the system can be improved.

The output of the piezoelectric sensor 1 (1A) is high in its output impedance and minute in its electric voltage. Accordingly, it is difficult to output the detection signal as it is to a control device such as an ECU (electronic control unit). Thus, a signal processing portion is provided in order to execute an impedance conversion, a signal process such as an amplification and a determining process for a primary entrapment. FIG. 6 illustrates a block circuit diagram schematically indicating an example of a configuration of such signal processing portion 10. The electrode 13 of the piezoelectric sensor 1A is connected to a ground commonly used with the signal processing portion 10, and the sensor output is taken out from the electrode 11.

An amplifier 4A is a core part of the DC amplifying means 4, and an operational amplifier, a FET or the like is used as the amplifier 4A. Because the operational amplifier or the FET is high in its input impedance, the input signal may not be attenuated. Thus, the amplifier 4A can receive the sensor output being high in its output impedance and being minute in its electric voltage with reducing the attenuation of the signal. The amplifier 4A applies DC amplification to the sensor output and outputs a signal of low impedance. Specifically, the amplifier 4A serves as a DC amplifying means 4, at the same time, it serves as an impedance converting means. The resistor 41, at an input side of the amplifier 4A, biases the output from the piezoelectric sensor 1A so as to be in a constant biased electric voltage v1. In this example, the biased electric voltage is set by dividing the power Vcc by means of the resistor 15 of the piezoelectric sensor 1A and the resistor 41 of the input side of the amplifier 4A.

The amplifier 5A is a core part of the AC amplifying means 5, and in the same manner as the DC amplifying means 4, an operational amplifier or a FET can be used as the amplifier 5A.

A coupling condenser 51 is provided at the input side of the amplifier 5A in order to cut DC elements from the output of the amplifier 4A and transmits only AC elements to the amplifier 5A. Between the coupling condenser 51 and the amplifier 5A, resistors 52 and 53 are provided in order to divide electric voltage between the power Vcc and the ground. The divided electric voltage biases the sensor output including only the AC elements and serves as a basic electric voltage of the amplifier 5A of the AC amplifying means 5.

A determining circuit 7A (determining means 7) is comprised of an operational amplifier, a comparator and the like. The determining circuit 7A primary determines the detection result detected by the piezoelectric sensor 1A on the basis of an amplitude of the sensor output which the AC amplification is applied and an electric characteristic value of frequency (cycle). The determination on the basis of the cycle includes a determination that, when the amplitude exceeds a threshold for more than a predetermined time period, the cycle is equal to or more than a predetermined cycle. This detection result is transmitted to the ECU 9 in order to determine whether or not a contact or an entrapment occurs. The determining means 7 may includes a partial function of such ECU 6.

The delaying means 3 according to the present invention is provided between the piezoelectric sensor 1A and the DC amplifying means 4 (amplifier 4A). In a block circuit diagram illustrated in FIG. 6, the condenser 31 connected to the piezoelectric sensor 1A so as to be parallel therewith corresponds to the delaying means 3. A RC circuit, which is comprised of the resistor 21 being a bias resistance relative to the input for the amplifier 4A, and a condenser 31, may serve as the delaying means. Further, a RC circuit, which is comprised of the resistor 15 provided at the piezoelectric sensor 1A and the condenser 31, may serve as the delaying means 3.

Furthermore, according to such sensor system, the sensor output is high in its impedance, and there is a high possibility that an exogenous noise is superposed thereon. Thus, a high cut filter (low-pass filter) for noise removal is often provided at an output portion of the sensor. The high cut filter is generally comprised of a RC filter and a LC filter, and due to these filters, the signal may delay. Accordingly, if such filter is provided at the sensor system, it may serve as the delaying means 3.

The piezoelectric body 12 being a component of the piezoelectric sensor 1A is also a ferroelectric and includes a stray capacitance. According to the cable type piezoelectric sensor 1A illustrated in FIG. 3, a size of this stay capacitance is in proportion to its length (1500 pF per meter). This stray capacitance may be included in the capacitance value of the condenser 31 of the delaying means 3. Because the stray capacitance relates to physicality of the piezoelectric body 12, it varies in accordance with the physicality variation such as deterioration on the piezoelectric body 12. Specifically, when the piezoelectric body deteriorates, its stray capacitance as a dielectric substance is also reduced. Thus, there is a correlation between the variation of the stray capacitance and the deterioration of the piezoelectric body.

The predetermined time period of the delaying executed by the delaying means 3 is approximately proportional to the capacitance value. For example, in a case where the RC circuit is used, the delaying time period, which is defined by a formula of time constant t=CR (C: capacitance value, R: resistance value), becomes in approximate proportion to the capacitance value. In a case where the capacitance value of the condenser 31, which configures the delaying means 3, includes the stray capacitance, the determining means 7 can determine a change of the stray capacitance on the basis of a change of the delaying time period. Because the change of the stray capacitance relates to deterioration of the piezoelectric body 12, the determining means 7 can determine deterioration of the piezoelectric body 12, specifically deterioration of the piezoelectric sensor 1A.

The determination of the deterioration of the piezoelectric sensor 1A may not be executed by the determining circuit 7A, and may be executed by an ECU 9. In this case, the ECU 9 also serves as the determining means 7. The ECU 9 memorizes an initial value such as the delaying time period at the time of manufacture, a capacitance value of the delaying means 3 obtained on the basis of the value of the delaying time period, and a stray capacitance value of the piezoelectric sensor 1A obtained by subtracting the capacitance value of the condenser 31 from the capacitance value. Then, every time the power is turned on, the determining means 7 determines whether the sensor output functions correctly or not and determines the value of the delaying time period on the basis of the, sensor output. Then, each of: the calculated delaying time period value; the capacitance value of the delaying means 3 obtained on the basis of the calculated delaying time period value; and the stray capacitance of the piezoelectric sensor 1A obtained on the basis of the capacitance value: is compared to the memorized initial value. On the basis of the comparison result, the deterioration of the piezoelectric sensor 1A is determined.

Further, the piezoelectric body 12 has a pyroelectric effect, and the sensor output thereof may include an output generated by a thermoelectric conversion. However, variations on the output generated by the thermoelectric conversion are much slower than the variations on the output generated by the mechanical external force. Thus, in general cases, the pyroelectric effect appears in the sensor output as a DC element. When the AC amplification is applied to the sensor output, the DC element is cut by means of the coupling condenser 51 at the previous stage of the AC amplification, the abovementioned effect can be suppressed to some extent. The pyroelectric effect may affect the stray capacitance, in other words, the pyroelectric effect may affect the determination of deterioration of the piezoelectric sensor 1A. Thus the deterioration result may be determined by a temperature sensor (not shown) by use of the ECU 9 memorizing an initial value with a temperature characteristic in consideration of temperature information obtained.

On the other hand, as illustrated in FIG. 6, a DC amplifying means 4 is generally provided in order to apply impedance converting to the output from the piezoelectric sensor 1A and for applying DC amplification to the output from the piezoelectric sensor 1A, before the AC amplifying. DC element generated by means of the thermoelectric conversion greatly affects the DC amplifying means 4. The AC type output generated by the piezoelectric effect may be affected. For example, a frequency and amplitude may differ depending on a change of hardness of the piezoelectric body caused by a rise in temperature. Further, as mentioned above, the pyroelectric effect affects the stray capacitance of the piezoelectric sensor. Thus, during a time period before the above mentioned age-related change appears, on the basis of the variation of the stray capacitance, an environmental change such as changes of temperature or humidity can be detected. Specifically, the determining means 7 can detect an environmental state or an environmental change by detecting the stray capacitance on the basis of the variation of the delaying time period.

The piezoelectric sensor system 50 illustrated in FIG. 7 adjusts the system by detecting such environmental state and environmental change. Specifically, the determining means 7 sets a criterion 7a of the determining means 7 and an amplification ratio 6a of the amplifying means 6 (the DC amplifying means 4 and the AC amplifying means 5). For example, a predetermined threshold relative to an electric characteristic value of the output from the amplifying means 6 (AC amplifying means 5) is set to the criterion 7a. The electric characteristic value can be, for example, amplitude and frequency (cycle). When the determination is executed on the basis of the cycle, it is determined that the cycle is equal to or greater than the predetermined cycle when a time period in which the amplitude exceeds a threshold is equal to or greater than a predetermined time period.

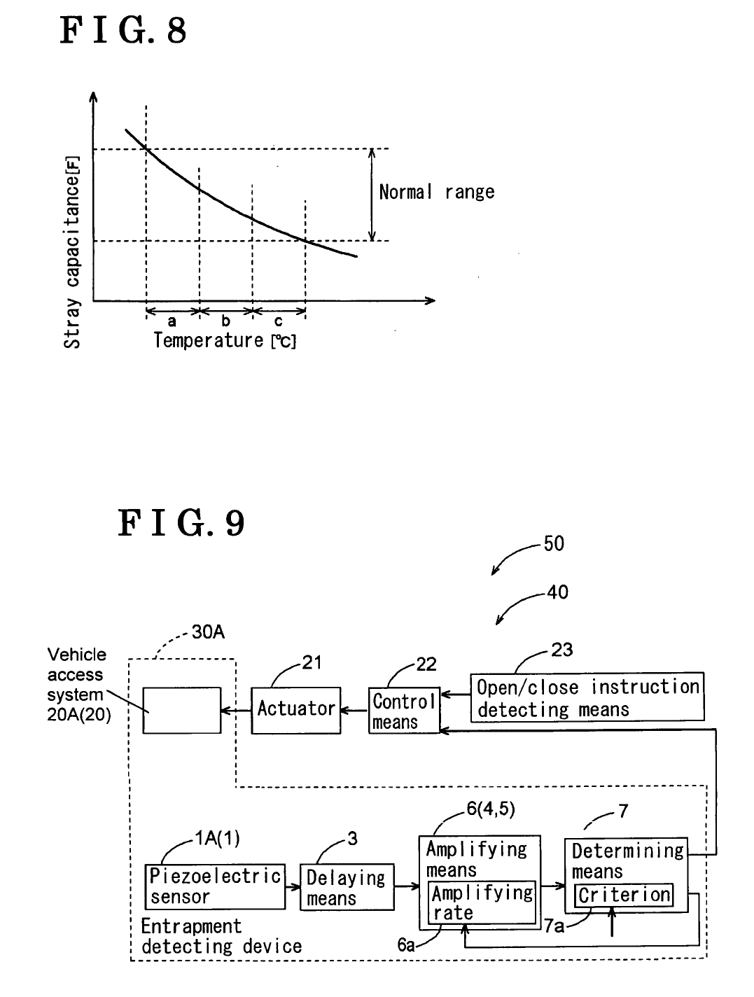

The determining means 7 sets the predetermined threshold on the basis of the delaying time period set by the delaying means 3. As mentioned above, the delaying time period varies in accordance with the change of the stray capacitance corresponding to the environmental change. Thus, the threshold of the criterion 7a is controlled so as to follow appropriately the environmental change by corresponding to the delaying time period. FIG. 8 illustrates an example of the characteristic indicating a relation between the stray capacitance and temperature. The determining means 7 determines that the piezoelectric sensor system 50 is not normal when the stray capacitance calculated on the basis of the delaying time period is larger than or smaller than the predetermined value. This is because temperature is exceeding an usage range or other factors affecting the piezoelectric sensor system 50 so as to render it abnormal. Within the range in which the value of the stray capacitance is normal, the determining means 7 determines the environmental condition corresponding to the value of the stray capacitance. In this example, in accordance with the environmental temperature, three temperature ranges a, b and c are determined. Then, the determining means set the criterion 7a (predetermined threshold) and the amplification ratio 6a corresponding to each temperature condition.

The piezoelectric sensor system 50 having such self-adjustment function may configure the entrapment-detecting device 30A according to the present invention. As explained in accordance with FIG. 5, power is supplied to the entrapment-detecting device 30A corresponding to the opening/closing operation of the opening/closing system 20. Specifically, the control means 22 starts supplying power to the piezoelectric sensor system 50 in accordance with the start of the power supply to, for example, the actuator 21. The piezoelectric sensor system according to the present invention executes a self-adjustment in accordance with the delaying time period after the power is supplied thereto. Thus, on every opening/closing operation, the self-adjustment is executed, as a result, reliability can be improved.

The piezoelectric sensor system according to the present invention includes both of the self-diagnosis function and the self-adjustment function.

As explained above, according to the present invention, the sensor system mainly executing an analog signal processing achieves the self-diagnosis function with a simple configuration. Further, the system achieves the adjustment function with a simple configuration. Further, the present invention provides an entrapment-detecting device for an opening/closing system.

According to the present embodiment, a point when the electric voltage of the power has reached a predetermined electric voltage, and the determining means can determine whether or not the external force is applied to the piezoelectric sensor, however, the output from the piezoelectric sensor does not reach the steady-state level. Because the output of the piezoelectric sensor is delayed for a predetermined delaying time period by means of the delaying means, the sensor output is in a transient state and has not reached the steady-stated level. Thus, the AC amplifying means would apply the AC amplification to the sensor output being a signal in a transient state The determining means determines whether or not the signal varies on the basis of the output from the AC amplifying means, and if the determining means determines that the variation exists on the signal, the determining means can determine whether or not the piezoelectric sensor system functions properly. When a time period during which the signal variation has continually occurred is significantly shorter or significantly longer than an assumed predetermined delaying time period, the determining means can determine that the piezoelectric sensor system does not function properly.

Thus, the sensor system mainly executing an analog signal processing achieves the self-diagnosis function with a simple configuration.

According to the present embodiment, the impedance by the condenser is indicated by (1/jωC), in which C means the capacitance. When the condenser is connected so as to be in parallel, the impedance is indicated by jωC. When the output from the piezoelectric sensor is in a transient state, the output includes the AC elements, not the DC elements.

Specifically, because the output is a signal having some kind of a frequency, an angular frequency (angular speed) ω is not zero. Thus, the impedance jωC is not zero and includes some impedance. Because of this impedance, the output from the piezoelectric sensor is delayed. Further, the condenser together with the resistor can easily regulates the predetermined delaying time period. For example, the time constant t can be obtained by multiplying a capacitance C by a resistance value R, and the delaying time period can be regulated by the time constant t. Thus, the sensor system having the delaying means with a simple configuration-achieves the self-diagnosis function.

According to the present invention, the piezoelectric body being a component of the piezoelectric sensor is also a ferroelectric and includes the stray capacitance. Because the stray capacitance relates to physicality of the piezoelectric body, it varies in accordance with the physicality variation such as deterioration on the piezoelectric body. Specifically, when the piezoelectric body deteriorates, its stray capacitance as a dielectric substance is also reduced. Thus, there is a correlation between the variation of the stray capacitance and the deterioration of the piezoelectric body. In a case where the capacitance value of the condenser, which configures the delaying means, includes the stray capacitance. Because the predetermined delaying time period is in proportion to the capacitance value, the determining means can determine a change of the stray capacitance on the basis of a change of the delaying time period. Because the change of the stray capacitance relates to deterioration of the piezoelectric body, the determining means can determine deterioration of the piezoelectric body, specifically deterioration of the piezoelectric sensor.

Further, the piezoelectric body has a pyroelectric effect, and the sensor output thereof may include an output generated by a thermoelectric conversion. However, variations on the output generated by the thermoelectric conversion arc much slower than the variations on the output generated by the mechanical external force. Thus, in general cases, the pyroelectric effect appears in the sensor output as a DC element. When the AC amplification is applied to the sensor output, the DC element is cut by means of the coupling condenser at the previous stage of the AC amplification, the abovementioned effect can be suppressed to some extent. On the other hand the DC amplifying means is generally provided in order to apply impedance converting to the output from the piezoelectric sensor and for applying amplification to the output from the piezoelectric sensor, before the AC amplifying DC element generated by means of the thermoelectric conversion greatly affects the DC amplifying means.

The AC type output generated by the piezoelectric effect may be affected. For example, a frequency and amplitude may differ depending on a change of hardness of the piezoelectric body caused by a rise in temperature.

Further, as mentioned above, the pyroelectric effect affects the stray capacitance of the piezoelectric sensor. Thus, during a time period before the above mentioned age-related change appears, on the basis of the variation of the stray capacitance, an environmental change such as changes of temperature or humidity can be detected. Specifically, the determining means can detect an environmental state or an environmental change by detecting the stray capacitance on the basis of the variation of the delaying time period. Thus, the determining means sets the criterion of the determining means and the amplification ratio of the amplifying means (the DC amplifying means and the AC amplifying means), Thus, with a simple configuration, the piezoelectric sensor system that can achieve the adjustment function corresponding to the environmental change can be provided.

According to the present embodiment, because the determining means determines on the basis of the electric characteristic value of the output from the amplifying means and the threshold for the electric characteristic value, the determining means can be configured with a simple circuit configuration. The determining means sets the predetermined threshold on the basis of the delaying time period set by the delaying means. The delaying time period varies in accordance with the change of the stray capacitance corresponding to the environmental change. Thus, the threshold of the criterion is controlled so as to follow appropriately the environmental change by corresponding to the delaying time period.

The entrapment of an object according to the present embodiment is not limited to the sandwich at the opening/closing members and includes a contact of the object to the opening/closing members before it is sandwiched.

Thus, an entrapment detecting device having the self-diagnosis and the adjustment function with a high reliability can be obtained by providing the piezoelectric sensor system of the present embodiment to the entrapment detecting device for detecting an entrapment of the object at the opening/closing members. Further, the piezoelectric body can be processed in various shapes such as a cable shape, and the entrapment detecting device having such piezoelectric body can be easily provided at an end portion of the opening/closing members.

Further, when the opening/closing system is not operated so as to be opened/closed, an entrapment caused by a sandwich condition does not occur. Further, even when the abutting (contact) of the object to the opening/closing members occurs, it is considered that a possibility where the object will be sandwiched is significantly low. Thus, the piezoelectric sensor system is turned on depending on the state of the opening/closing system, accordingly an unused stand-by electric power may not be consumed. Furthermore, according to the present embodiment, depending on the delaying time period after the power is sullied to the sensor system, the self-diagnosis and the adjustment diagnosis are executed. Thus, the self-diagnosis and the adjustment diagnosis are executed on every opening/closing operation, reliability of the system can be improved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A piezoelectric sensor system comprising:
a piezoelectric sensor for outputting an electric voltage in accordance with a mechanical external force;
delaying means for delaying the output from the piezoelectric sensor for a predetermined delaying time period;
AC amplifying means for applying AC amplification to the output from the piezoelectric sensor via the delaying means; and
determining means for determining whether or not the external force is applied to the piezoelectric sensor, on the basis of the output from the AC amplifying means and for determining whether or not the piezoelectric sensor system normally operates on the basis of the output from the AC amplifying means during the delaying time period.

2. The piezoelectric sensor system according to claim 1, wherein
the delaying means includes a condenser connected to the piezoelectric sensor so as to be in parallel with the piezoelectric sensor and having a capacitance value for setting the delaying time period.

3. The piezoelectric sensor system according to claim 2, wherein
the capacitance value of the condenser includes a value of a stray capacitance included by the piezoelectric sensor, and the determining means determines aged deterioration of the piezoelectric sensor on the basis of aging during the delaying time period.

4. A piezoelectric sensor system comprising:
a piezoelectric sensor for outputting an electric voltage in accordance with a mechanical external force;
delaying means for delaying the output from the piezoelectric sensor for a predetermined delaying time period;
AC amplifying means for applying AC amplification to the output from the piezoelectric sensor via the delaying means; and
determining means for determining whether or not the external force is applied to the piezoelectric sensor, on the basis of the output from the AC amplifying means and for setting one of an amplification ratio of the AC amplifying means and a criteria of the determining means on the basis of the delaying time period.

5. The piezoelectric sensor system according to claim 4, wherein
the determining means determines whether or not an external force is applied to the piezoelectric sensor on the basis of an electric characteristic value of the output from the amplifying means and on the basis of a predetermined threshold being set based upon the delaying time period as a criterion relative to the electric characteristic value.

6. The piezoelectric sensor system according to claim 4,
wherein the delaying means includes a condenser connected to the piezoelectric sensor so as to be in parallel with the piezoelectric sensor and having a capacitance value for setting the delaying time period, the capacitance value of the condenser includes a value of a stray capacitance included by the piezoelectric sensor, and the determining means determines an environmental state or an environmental change on the basis of the delaying time period.

7. An entrapment-detecting device comprising:
an opening/closing system having opening/closing members and operated so as to be opened/closed by means of a driving force from an actuator;
a piezoelectric sensor provided at an end portion of the opening/closing members for outputting an electric voltage in accordance with a mechanical external force;
delaying means for delaying the output from the piezoelectric sensor for a predetermined delaying time period;
AC amplifying means for applying AC amplification to the output from the piezoelectric sensor via the delaying means; and
determining means for determining whether or not the external force is applied to the piezoelectric sensor, on the basis of the output from the AC amplifying means, in order to detect an entrapment of an object at the opening/closing members and for determining whether or not entrapment-detecting device normally operates on the basis of the output from the AC amplifying means during the delaying time period.

8. The entrapment-detecting device according to claim 7, wherein
the determining means for setting one of an amplification ratio of the AC amplifying means and a criteria of the determining means on the basis of the delaying time period.

9. The entrapment-detecting device according to claim 7, wherein
an electric power is supplied to the entrapment-detecting device in accordance with an opening/closing operation of the opening/closing system, and
the delaying time period indicates an elapsed time after the electric power is supplied to the entrapment-detecting device.
